(19) United States
(12) Patent Application Publication
(10) Pub. No.: US 2026/0327001 A1
(43) Pub. Date: Oct. 22, 2026

(54) LIQUID LEVEL GAUGE FOR MEASURING AND MONITORING A LIQUID LEVEL IN AN ISOTAINER AND METHOD THEREFOR

(71) Applicant: David Beserra, Sonora, TX (US)

(72) Inventor: David Beserra, Sonora, TX (US)

(21) Appl. No.: 19/181,459

(22) Filed: Apr. 17, 2025

(51) Int. Cl. B65D 90/48; G01F 23/64

(52) U.S. Cl. CPC B65D 90/48; G01F 23/64

(57) ABSTRACT

A liquid level gauge for measuring and monitoring a liquid level in an isotainer includes a T-pipe, a female coupler, a male coupler, and a tube. The T-pipe includes a main conduit and a side conduit. The female coupler is coupled to a first conduit end and designed to couple to an isotainer outlet valve. The male coupler is coupled to a second conduit end and designed to couple to an outlet line. The tube is coupled to the side conduit of the T-pipe such that the tube extends upwardly. The tube includes a plurality of measurement markings on an outer tube surface. The tube includes translucent material to view a portion of the liquid from the isotainer that has flowed into the tube when the liquid is flowed out of the isotainer outlet valve, which portion of liquid represents a level of the liquid in the isotainer.

### B. CROSS-REFERENCE TO RELATED APPLICATIONS

Not Applicable

### C. STATEMENT REGARDING FEDERALLY SPONSORED RESEARCH OR DEVELOPMENT

Not Applicable

### D. THE NAMES OF THE PARTIES TO A JOINT RESEARCH AGREEMENT

Not Applicable

### E. INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### F. STATEMENT REGARDING PRIOR DISCLOSURES BY THE INVENTOR OR JOINT INVENTOR

Not Applicable

### G. BACKGROUND OF THE INVENTION

### 1. Field of the Invention

The disclosure relates to gauges for the oil and gas industry and more particularly pertains to a new liquid level gauge for measuring and monitoring a liquid level in an isotainer. An isotainer (ISO tank container) in the oil and gas industry is a specialized, standardized container designed for transporting and storing bulk liquids, including crude oil, refined petroleum products, chemicals, and liquefied gases. These containers conform to ISO (International Organization for Standardization) standards, ensuring compatibility with global transportation systems such as ships, trucks, and rail. When draining the isotainer of its contents, a worker must climb on top of the isotainer to view inside through a top portal, which can be dangerous due to the height. To eliminate this risk, the new liquid level gauge allows the worker to monitor the liquid level in the isotainer from the ground by connecting to the isotainer outlet valve.

### 2. Description of Related Art including information disclosed under 37 CFR 1.97 and 1.98

The prior art relates to gauges for the oil and gas industry. The prior art, as best understood, does not disclose a liquid level gauge for measuring and monitoring a liquid level in an isotainer that includes a T-pipe, a female coupler, a male coupler, and a tube. The T-pipe is coupled by the female coupler to an isotainer outlet valve and coupled by the male coupler to an outlet line of a container to the first conduit end. The tube is coupled to the T-pipe and includes a plurality of measurement markings on an outer tube surface. The tube includes translucent material to view a portion of the liquid from the isotainer that has flowed into the tube when the liquid is flowed out of the isotainer outlet valve and through the T-pipe, which portion of liquid represents a level of the liquid in the isotainer.

### H. BRIEF SUMMARY OF THE INVENTION

An embodiment of the disclosure meets the needs presented above in a liquid level gauge generally comprising a T-pipe, a female coupler, a male coupler, and a tube. The T-pipe includes a main conduit and a side conduit extending perpendicularly from a middle of the main conduit. The main conduit includes a first conduit end and a second conduit end. The female coupler is coupled to the first conduit end. The female coupler is designed to couple the T-pipe to an isotainer outlet valve. The male coupler is coupled to the second conduit end. The male coupler is designed to couple the T-pipe to an outlet line for flow of liquid out of the isotainer outlet valve, through the T-pipe, and into a container. The tube is coupled to the side conduit of the T-pipe such that the tube extends upwardly when the T-pipe is connected to the isotainer outlet valve. The tube includes a plurality of measurement markings on an outer tube surface. The tube includes translucent material to view a portion of the liquid from the isotainer that has flowed into the tube when the liquid is flowed out of the isotainer outlet valve and through the T-pipe, which portion of liquid represents a level of the liquid in the isotainer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I. BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a perspective view of a liquid level gauge according to an embodiment of the disclosure.

FIG. 2 is a front view of an embodiment of the disclosure.

FIG. 3 is a side view of an embodiment of the disclosure.

FIG. 4 is a side cross-sectional view of the embodiment of the disclosure.

FIG. 5 is a perspective view of an embodiment of the disclosure in use.

FIG. 6 is a front view of an embodiment of the disclosure in use.

FIG. 7 is a perspective view of a lighting unit.

### J. DETAILED DESCRIPTION OF THE INVENTION

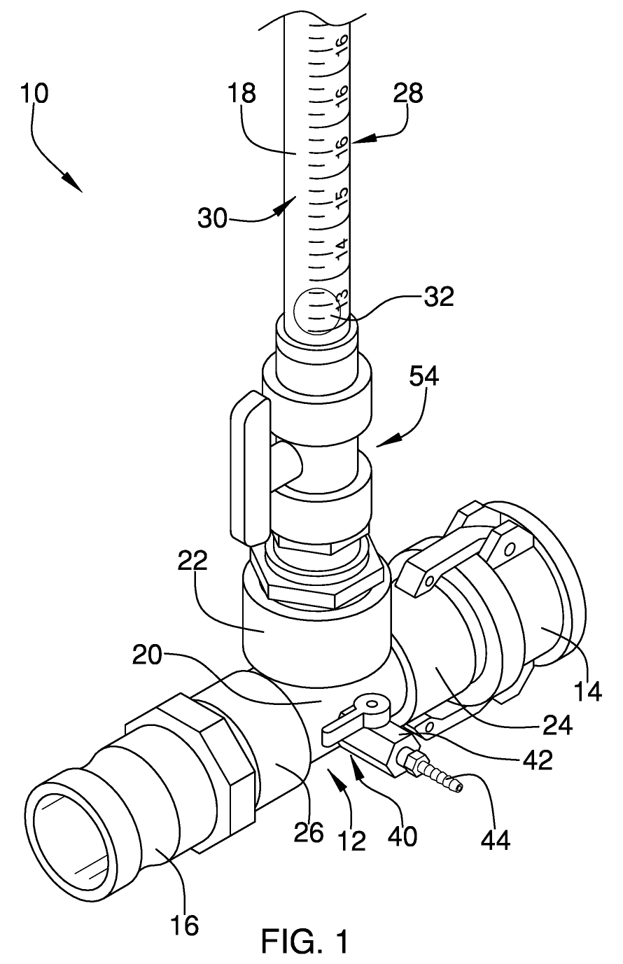

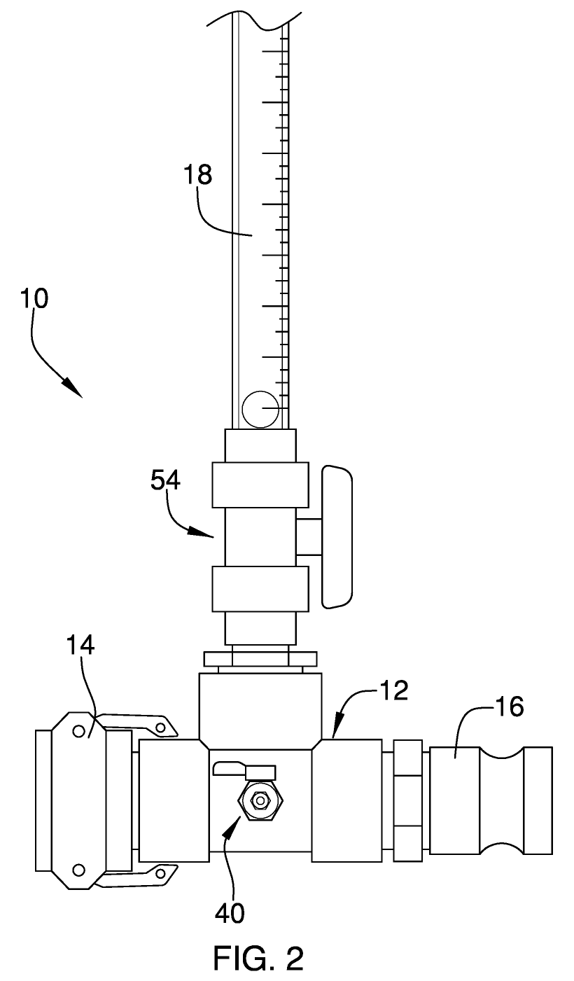

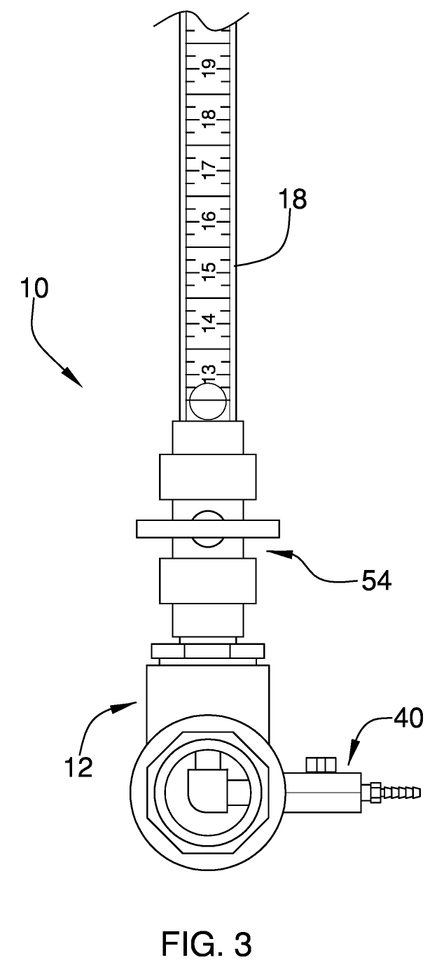

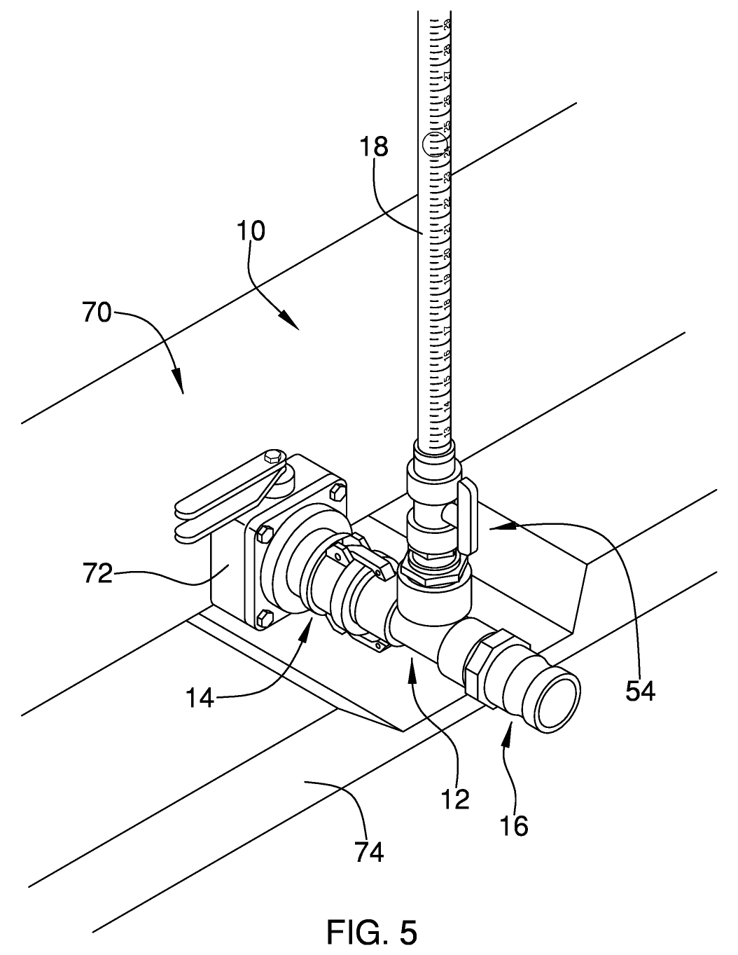

With reference now to the drawings, and in particular to FIGS. 1-7 thereof, a new liquid level gauge embodying the principles and concepts of an embodiment of the disclosure and generally designated by the reference numeral 10 will be described.

As best illustrated in FIGS. 1-7, the liquid level gauge 10 for measuring and monitoring a liquid level in an isotainer 70 generally comprises a T-pipe 12, a female coupler 14, a male coupler 16, and a tube 18. The T-pipe 12 includes a main conduit 20 and a side conduit 22 extending perpendicularly from a middle of the main conduit 20. The main conduit 20 includes a first conduit end 24 and a second conduit end 26. The female coupler 14 is coupled to the first conduit end 24. The female coupler 14 is designed to couple the T-pipe 12 to an isotainer outlet valve 72. The male coupler 16 is coupled to the second conduit end 26. The male coupler 16 is designed to couple the T-pipe 12 to an outlet line for flow of liquid out of the isotainer outlet valve 72, through the T-pipe 12, and into a container. The tube 18 is coupled to the side conduit 22 of the T-pipe 12 such that the tube 18 extends upwardly when the T-pipe 12 is connected to the isotainer outlet valve 72. The tube 18 includes a plurality of measurement markings 28 on an outer tube surface 30. The tube 18 includes translucent material to view a portion of the liquid from the isotainer 70 that has flowed into the tube 18 when the liquid is flowed out of the isotainer outlet valve 72 and through the T-pipe 12, which portion of liquid represents a level of the liquid in the isotainer 70.

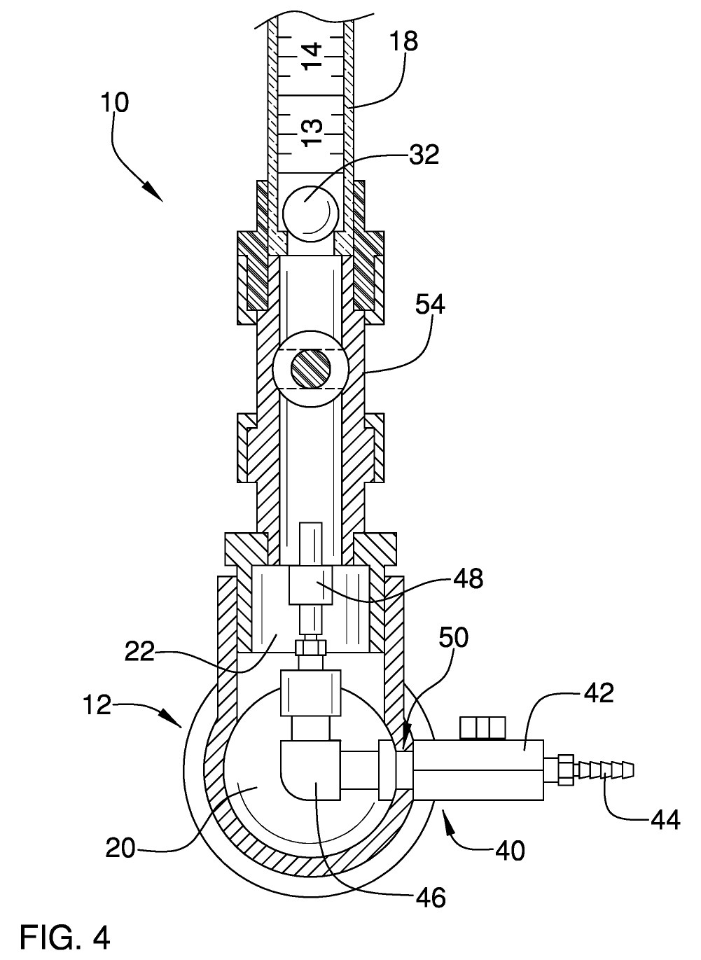

In the exemplary embodiment in FIGS. 1 and 4, the liquid level gauge 10 also includes a ball valve 54. The ball valve 54 is coupled to the tube 18 and the side conduit 22 of the T-pipe 12. The ball valve 54 is openable and closable to control flow of the liquid into the tube 18.

In the exemplary embodiment in FIGS. 1 and 4, the liquid level gauge 10 also includes a level sight ball 32. The level sight ball 32 is positioned inside the tube 18. The level sight ball 32 is buoyant such that the level sight ball 32 floats to the surface of the portion of the liquid in the tube 18 to facilitate viewing and measurement of the level of the portion of the liquid in the tube 18.

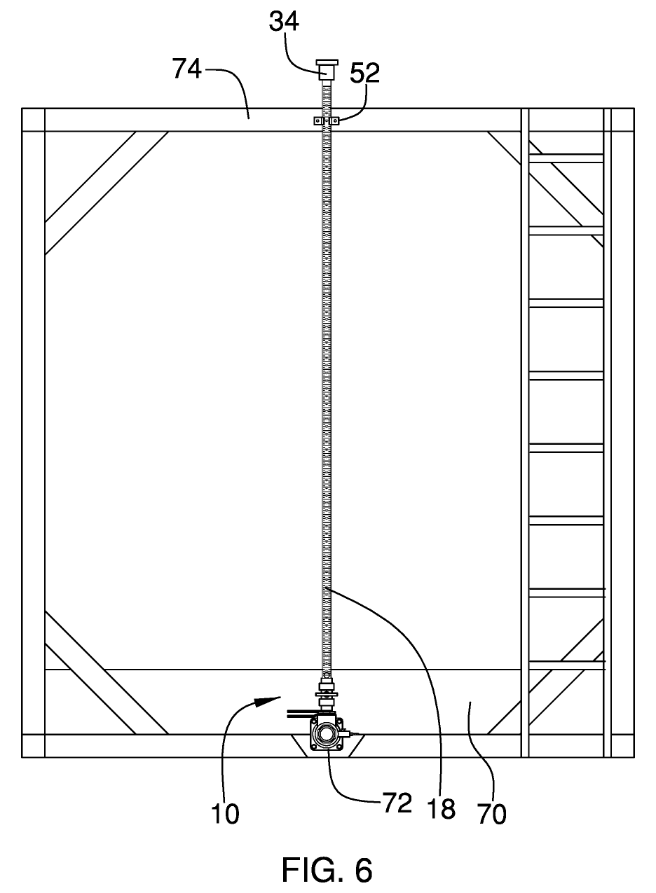

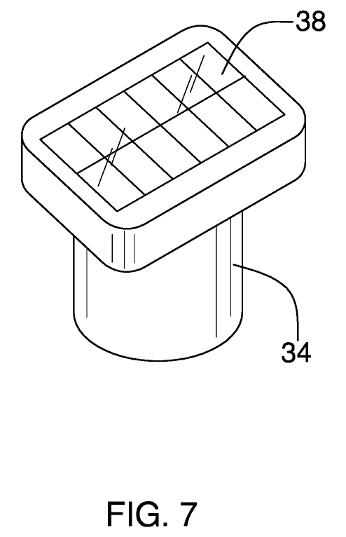

In the exemplary embodiment in FIG. 6, the liquid level gauge 10 also includes a lighting unit 34. The lighting unit 34 is coupled to a free end 36 of the tube 18. The lighting unit 34 is designed to illuminate the tube 18 to facilitate viewing and measurement of the level of the portion of the liquid in the tube 18. In the exemplary embodiment in FIG. 7, the lighting unit 34 includes a solar panel assembly 38 to supply power.

In the exemplary embodiment in FIGS. 1 and 4, the liquid level gauge 10 also includes an aerator assembly 40. The aerator assembly 40 is coupled to and passing through an aperture 50 in the T-pipe 12. The aerator assembly 40 is designed to conduct air into the portion of the liquid in the tube 18 to minimize freezing of the portion of the liquid in the tube 18 in cold temperatures.

The aerator assembly 40 includes an aerator valve 42, a nipple 44, an elbow fitting 46, and a check valve 48. The aerator valve 42 is positioned to project out from the aperture 50 of the T-pipe 12. The nipple 44 is coupled to the aerator valve 42. The nipple 44 is designed to couple to an aeration hose of an aeration pump (not shown). The elbow fitting 46 is coupled to the aerator valve 42. The elbow fitting 46 is positioned inside the T-pipe 12 and projects from the main conduit 20 into the side conduit 22. The check valve 48 is coupled to the elbow fitting 46. The check valve 48 is positioned in the side conduit 22 and projects into the tube 18.

In one possible embodiment, the tube 18 includes a blue tint to minimize sun discoloration and damage of the tube 18 caused by ultraviolet exposure. In another possible embodiment, each of the female coupler 14 and the male coupler 16 is a camlock fitting.

In the exemplary embodiment in FIG. 6, the liquid level gauge 10 also includes a bracket assembly 52. The bracket assembly 52 is coupled to the tube 18. The bracket assembly 52 is designed to secure the tube 18 to an upper portion of a frame 74 supporting the isotainer 70 to stabilize the tube 18.

In one possible embodiment, the tube 18 has a length of at least 100.0 inches and a diameter of at least 1.5 inches. However, the tube 18 can be whatever size is suitable for reflecting the level of the liquid in the isotainer 70.

The liquid level gauge 10 is used to measure and monitor a liquid level in the isotainer 70 during draining of the isotainer 70. A worker couples the female coupler 14 to an isotainer outlet valve 72 with the tube 18 positioned to extend upwardly. The worker also couples an outlet line to the male coupler 16. The user then opens the isotainer outlet valve 72 to flow a liquid in the isotainer 70 into the main conduit 20 of the T-pipe 12. A portion of the liquid is diverted via the side conduit 22 into the tube 18 to a level that represents a level of the liquid in the isotainer 70. The worker can now measure the level of the portion of the liquid in the tube 18 using the measurement markings 28. The worker can monitor the level of the portion of the liquid in the tube 18 and thereby monitor the level of the liquid in the isotainer 70, but without having to climb up on the isotainer 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A liquid level gauge for measuring and monitoring a liquid level in an isotainer comprising:
a T-pipe, the T-pipe including a main conduit and a side conduit extending perpendicularly from a middle of the main conduit, the main conduit including a first conduit end and a second conduit end;
a female coupler, the female coupler being coupled to the first conduit end, the female coupler being configured to couple the T-pipe to an isotainer outlet valve;
a male coupler, the male coupler being coupled to the second conduit end, the male coupler being configured to couple the T-pipe to an outlet line for flow of liquid out of the isotainer outlet valve, through the T-pipe, and into a container; and
a tube, the tube being coupled to the side conduit of the T-pipe such that the tube extends upwardly when the T-pipe is connected to the isotainer outlet valve, the tube including a plurality of measurement markings on an outer tube surface, the tube includes translucent material to view a portion of the liquid from the isotainer that has flowed into the tube when the liquid is flowed out of the isotainer outlet valve and through the T-pipe, which portion of liquid represents a level of the liquid in the isotainer.

2. The liquid level gauge of claim 1, further comprising a ball valve, the ball valve being coupled to the tube and the side conduit of the T-pipe, the ball valve being openable and closable to control flow of the liquid into the tube.

3. The liquid level gauge of claim 1, further comprising a level sight ball, the level sight ball being positioned inside the tube, the level sight ball being buoyant such that the level sight ball floats to the surface of the portion of the liquid in the tube to facilitate viewing and measurement of the level of the portion of the liquid in the tube.

4. The liquid level gauge of claim 1, further comprising a lighting unit, the lighting unit being coupled to a free end of the tube, the lighting unit being configured to illuminate the tube to facilitate viewing and measurement of the level of the portion of the liquid in the tube.

5. The liquid level gauge of claim 4, wherein the lighting unit includes a solar panel assembly to supply power.

6. The liquid level gauge of claim 1, further comprising an aerator assembly, the aerator assembly being coupled to and passing through an aperture in the T-pipe, the aerator assembly being configured to conduct air into the portion of the liquid in the tube to minimize freezing of the portion of the liquid in the tube in cold temperatures.

7. The liquid level gauge of claim 1, wherein the aerator assembly comprises;
an aerator valve, the aerator valve is positioned to project out from the aperture of the T-pipe;
a nipple, the nipple is coupled to the aerator valve, the nipple is configured to couple to an aeration hose of an aeration pump;
an elbow fitting, the elbow fitting is coupled to the aerator valve, the elbow fitting is positioned inside the T-pipe and projects from the main conduit into the side conduit; and
a check valve, the check valve is coupled to the elbow fitting, the check valve is positioned in the side conduit and projects into the tube.

8. The liquid level gauge of claim 1, wherein the tube includes a blue tint to minimize sun discoloration and damage of the tube caused by ultraviolet exposure.

9. The liquid level gauge of claim 1, wherein each of the female coupler and the male coupler is a camlock fitting.

10. The liquid level gauge of claim 1, further comprising a bracket assembly, the bracket assembly being coupled to the tube, the bracket assembly being configured to secure the tube to an upper portion of a frame supporting the isotainer to stabilize the tube.

11. The liquid level gauge of claim 1, wherein the tube has a length of at least 100.0 inches and a diameter of at least 1.5 inches.

12. The liquid level gauge of claim 2, further comprising a level sight ball, the level sight ball being positioned inside the tube, the level sight ball being buoyant such that the level sight ball floats to the surface of the portion of the liquid in the tube to facilitate viewing and measurement of the level of the portion of the liquid in the tube.

13. The liquid level gauge of claim 12, further comprising a lighting unit, the lighting unit being coupled to a free end of the tube, the lighting unit being configured to illuminate the tube to facilitate viewing and measurement of the level of the portion of the liquid in the tube.

14. The liquid level gauge of claim 13, wherein the lighting unit includes a solar panel assembly to supply power.

15. The liquid level gauge of claim 14, further comprising an aerator assembly, the aerator assembly being coupled to and passing through an aperture in the T-pipe, the aerator assembly being configured to conduct air into the portion of the liquid in the tube to minimize freezing of the portion of the liquid in the tube in cold temperatures.

16. The liquid level gauge of claim 15, wherein the aerator assembly comprises;
an aerator valve, the aerator valve is positioned to project out from the aperture of the T-pipe;
a nipple, the nipple is coupled to the aerator valve, the nipple is configured to couple to an aeration hose of an aeration pump;
an elbow fitting, the elbow fitting is coupled to the aerator valve, the elbow fitting is positioned inside the T-pipe and projects from the main conduit into the side conduit; and
a check valve, the check valve is coupled to the elbow fitting, the check valve is positioned in the side conduit and projects into the tube.

17. The liquid level gauge of claim 16, wherein the tube includes a blue tint to minimize sun discoloration and damage of the tube caused by ultraviolet exposure.

18. The liquid level gauge of claim 17, wherein each of the female coupler and the male coupler is a camlock fitting, and the tube has a length of at least 100.0 inches and a diameter of at least 1.5 inches.

19. The liquid level gauge of claim 18, further comprising a bracket assembly, the bracket assembly being coupled to the tube, the bracket assembly being configured to secure the tube to an upper portion of a frame supporting the isotainer to stabilize the tube.

20. A method of measuring and monitoring a liquid level in an isotainer during draining of the isotainer, the method comprising the steps of:
providing a liquid level gauge for measuring and monitoring a liquid level in an isotainer comprising:
a T-pipe, the T-pipe including a main conduit and a side conduit extending perpendicularly from a middle of the main conduit, the main conduit including a first conduit end and a second conduit end;
a female coupler, the female coupler being coupled to the first conduit end, the female coupler being configured to couple the T-pipe to an isotainer outlet valve;
a male coupler, the male coupler being coupled to the second conduit end, the male coupler being configured to couple the T-pipe to an outlet line for flow of liquid out of the isotainer outlet valve, through the T-pipe, and into a container; and
a tube, the tube being coupled to the side conduit of the T-pipe such that the tube extends upwardly when the T-pipe is connected to the isotainer outlet valve, the tube including a plurality of measurement markings on an outer tube surface, the tube includes translucent material to view a portion of the liquid from the isotainer that has flowed into the tube when the liquid is flowed out of the isotainer outlet valve and through the T-pipe, which portion of liquid represents a level of the liquid in the isotainer;
coupling the female coupler to an isotainer outlet valve with the tube positioned to extend upwardly;
coupling an outlet line to the male coupler;
opening the isotainer outlet valve and flowing a liquid in the isotainer into the main conduit of the T-pipe, wherein a portion of the liquid is diverted via the side conduit into the tube to a level that represents a level of the liquid in the isotainer;
measuring the level of the portion of the liquid in the tube using the measurement markings; and
monitoring the level of the portion of the liquid in the tube and thereby monitoring the level of the liquid in the isotainer.
